(19) United States
(12) Patent Application Publication
(10) Pub. No.: US 2025/0319941 A1
(43) Pub. Date: Oct. 16, 2025

(54) HANDLEBAR ASSEMBLY AND BICYCLE

(71) Applicant: DAHON TECH (SHENZHEN) CO., LTD., Shenzhen (CN)

(72) Inventors: Jingfeng LI, Shenzhen (CN); David Tak Wei HON, Shenzhen (CN)

(21) Appl. No.: 19/095,807

(22) Filed: Mar. 31, 2025

(30) Foreign Application Priority Data
Jan. 31, 2024 (CN) 202420253562.6

(51) Int. Cl. B62K 21/16

(52) U.S. Cl. CPC B62K 21/16

(57) ABSTRACT

A handlebar assembly includes a stem, a handlebar, and a limiting structure. A side circumference of the stem is provided with a limiting hole, and the handlebar includes a grip and a support tube, either of the support tube and the stem being rotatably sleeved with the other, and a side circumference of the support tube being provided with a positioning hole. The limiting structure includes a limiting member movably connected to the handlebar, the limiting member being capable of moving to an unlocking position and a locking position relative to the handlebar, at least a part of the limiting member being inserted into the positioning hole and the limiting hole simultaneously to lock the handlebar and the stem at the locking position, the limiting member being separated from the limiting hole and the positioning hole at the unlocking position, and the handlebar being rotatable relative to the stem.

### CROSS-REFERENCE TO RELATED APPLICATIONS

This application claims priority of Chinese Patent Application No. 202420253562.6, filed on Jan. 31, 2024, entitled “HANDLEBAR ASSEMBLY AND BICYCLE”, the entire content of which is incorporated herein by reference in its entirety.

### TECHNICAL FIELD

The present application relates to the field of bicycle technologies, and in particular, to a handlebar assembly and a bicycle.

### BACKGROUND

As a tool for riding instead of walking, a bicycle plays an important role in the daily life of people. A handlebar is an essential component for controlling an advance direction of the bicycle. A front fork of a traditional bicycle is provided with a wheel, the front fork is fixed to a stem, and the handlebar is fixed to the stem to control a swing direction of the wheel of the front fork.

However, when the traditional bicycle is parked, since a left-right size of the handlebar is large, that is, a size of the handlebar in a width direction of the bicycle is large, the handlebar occupies a large space, and if a large number of bicycles are parked in a designated parking region, the handlebar is prone to interfere with and be scratched by other adjacent vehicles due to two protruding ends thereof, thereby limiting an upper limit of the number of the bicycles that can be parked in the designated parking region, making parking and taking of the vehicles difficult, and lowering bicycle use experiences of a user.

The above information disclosed in the background of the present application is only used for understanding a background of the inventive concept and may contain information that does not constitute the prior art.

### SUMMARY

Based on this, it is necessary to provide a handlebar assembly and a bicycle to solve the above problem.

A handlebar assembly includes:
a stem, a side circumference of the stem being provided with a limiting hole;
a handlebar comprising a grip and a support tube fixed to the grip, one of the support tube and the stem being rotatably sleeved with another, and a side circumference of the support tube being provided with a positioning hole; and
a limiting structure comprising a limiting member movably connected to the handlebar, the limiting member being capable of moving between an unlocking position and a locking position relative to the handlebar, wherein when the limiting member is at the locking position, at least a part of the limiting member is inserted into the positioning hole and the limiting hole simultaneously to lock the handlebar and the stem, and when the limiting member is at the unlocking position, the limiting member is disengaged from the limiting hole and the positioning hole, such that the handlebar is rotatable relative to the stem.

The above handlebar assembly at least achieves the following beneficial effects: the stem may be fixed to a front fork of a bicycle for controlling a travel direction of a wheel on the front fork. When the bicycle with the handlebar assembly is ridden, at the unlocking position, the handlebar is rotatable relative to the stem, and in this case, the whole handlebar can be rotated into a state of being substantially perpendicular to the wheel of the front fork, i.e., the state that the handlebar is substantially perpendicular to a frame, the limiting structure is then moved to the locking position to relatively fix the handlebar and the stem, and in this case, the handlebar can drive the stem to rotate together. It can be understood that this conforms to bicycle using habits of a user during riding, the user faces the handlebar, and two hands can naturally rest on the handlebar in front of the body. If the bicycle with the handlebar assembly is parked in a designated parking region, a number of bicycles in the designated region is large, and distances between the bicycles are small, the bicycle with the handlebar assembly according to the present application has advantages, the limiting member can be moved to the unlocking position, the handlebar can be rotated relative to the stem in this case, the handlebar can be rotated to a position where the handlebar is substantially parallel to the frame, that is, the handlebar is attached to a bicycle body, the front wheel does not need to rotate, and the front wheel can also be kept at a position where the front wheel is substantially parallel to the frame, thus reducing a size of the handlebar in a width direction of the bicycle body, reducing a size in the width direction of the bicycle body occupied by the inclined wheel, facilitating parking and taking of the bicycle in a limited space, reducing mutual interference and scratching between the bicycle and other adjacent vehicles, and reducing the risk of bicycle damage to the greatest extent.

In an embodiment, the limiting holes include a first limiting hole and a second limiting hole, the first limiting hole and the second limiting hole are spaced apart along a circumferential direction of the stem; the locking positions include a first locking position and a second locking position, when the limiting member is at the first locking position, the positioning hole is aligned with the first limiting hole, and the limiting member is inserted into the positioning hole and the first limiting hole, and when the limiting member is at the second locking position, the positioning hole is aligned with the second limiting hole, and the limiting member is inserted into the positioning hole and the second limiting hole. For example, when the bicycle with the handlebar assembly is ridden, at the unlocking position, the handlebar is rotatable relative to the stem, and in this case, the whole handlebar can be rotated into the state of being substantially perpendicular to the wheel of the front fork, i.e., the state that the handlebar is substantially perpendicular to the frame, the limiting structure is then moved to the first locking position to relatively fix the handlebar and the stem, and in this case, the handlebar can drive the stem to rotate together. It can be understood that this conforms to the bicycle using habits of the user during riding, the user faces the handlebar, and double hands can naturally rest on the handlebar in front of the body. For another example, if the bicycle with the handlebar assembly is parked in the designated parking region, the number of the bicycles in the designated region is large, and the distances between the bicycles are small, the bicycle with the handlebar assembly according to the present application has advantages, the limiting member can be moved to the unlocking position, the handlebar can be rotated relative to the stem in this case, the handlebar can be rotated to the position where the handlebar is substantially parallel to the frame, that is, the handlebar is attached to the bicycle body, the front wheel does not need to rotate, and the front wheel can also be kept at the position where the front wheel is substantially parallel to the frame, thus reducing the size of the handlebar in the width direction of the bicycle body, reducing the size in the width direction of the bicycle body occupied by the inclined wheel, facilitating the parking and taking of the bicycle in the limited space, reducing the mutual interference and scratching between the bicycle and other adjacent vehicles, and reducing the risk of bicycle damage to the greatest extent. In order to prevent the handlebar from swinging in a parking process, the limiting structure can be moved to the second locking position, and the limiting member is inserted into the positioning hole and the second limiting hole simultaneously, so that the handlebar is kept fixed while being adjacent to the bicycle body.

In an embodiment, an axial extension line of the first limiting hole and an axial extension line of the second limiting hole are arranged to form an angle.

In an embodiment, the axial extension line of the first limiting hole and the axial extension line of the second limiting hole are arranged to form at an angle of 90 degrees. It may be understood that in a more preferred embodiment, the handlebar located at the first locking position is substantially perpendicular to the front wheel during riding, and the handlebar located at the second locking position is preferably substantially parallel to the bicycle body and the front wheel during parking. In other words, the handlebar located at the first locking position is substantially perpendicular to the handlebar located at the second locking position, and in order to achieve this effect, the axial extension line of the first limiting hole and the axial extension line of the second limiting hole are arranged at the included angle of 90 degrees in this embodiment.

In an embodiment, a guide bump is further arranged on an outer side circumference of the stem, a guide sliding groove is provided in the side circumference of the support tube, the guide bump is slidably provided in the guide sliding groove, and the guide bump abuts against a groove wall of the guide sliding groove to limit movement of the support tube in an axial direction of the stem and limit a rotation angle of the support tube in the circumferential direction of the stem. The guide bump is inserted into the guide sliding groove, and the guide bump abuts against the groove wall of the guide sliding groove in the axial direction of the stem, so that movement of the handlebar and the stem in the axial direction can be limited, and the handlebar and the stem are prevented from being separated. In addition, since a length extending direction of the guide sliding groove is limited, a sliding stroke of the guide bump in the guide sliding groove is limited, and therefore, a rotating stroke of the handlebar relative to the stem is also limited.

In an embodiment, the guide sliding groove is arranged to extend along the circumferential direction of the stem, the guide sliding groove has a first end and a second end in the circumferential direction of the stem, the positioning hole is aligned with the first limiting hole when a groove wall of the first end of the guide sliding groove abuts against the guide bump, and the positioning hole is aligned with the second limiting hole when a groove wall of the second end of the guide sliding groove abuts against the guide bump. Such a structure arrangement has the advantages that, specifically, when the handlebar rotates to the state of being substantially perpendicular to the front wheel, the guide bump can be arranged to just abut against the groove wall of the first end of the guide sliding groove, the positioning hole is just aligned with the first limiting hole, and in this case, the limiting structure is inserted into the positioning hole and the first limiting hole, and the handlebar is fixed to the stem. That is, the limiting structure is quickly positioned to the first locking position. Similarly, when the handlebar rotates to a state of being substantially parallel to the front wheel, the guide bump can be arranged to just abut against the groove wall of the second end of the guide sliding groove, the positioning hole is just aligned with the second limiting hole, and in this case, the limiting structure is inserted into the positioning hole and the second limiting hole, and the handlebar is fixed to the stem. That is, the limiting structure is quickly positioned to the second locking position. In other words, the groove wall of the first end of the guide sliding groove and the groove wall of the second end of the guide sliding groove can abut against the guide bump, so as to achieve a positioning effect on relative rotation of the handlebar and the stem, so that the user can conveniently rotate the handlebar to the first locking position and the second locking position relative to the stem.

In an embodiment, the guide bump is a screw, and the guide bump is in threaded connection to the side circumference of the stem.

In an embodiment, the limiting structure further includes a fixing sleeve sleeved on an outer side circumference of the support tube and a handle rotatably connected to the fixing sleeve, and the limiting member is arranged on a side of the handle adjacent to the support tube.

In an embodiment, a side circumference of the fixing sleeve is further provided with an avoiding hole, the avoiding hole is aligned with the positioning hole, and at the locking position, the limiting member at least partially extends through the avoiding hole and the positioning hole to be inserted into the limiting hole.

In an embodiment, the limiting member is a pin, and the pin extends through the handle and is fixed to the handle.

In an embodiment, the limiting member is at least partially matched with the limiting hole, and the limiting hole is matched with the positioning hole. With such a structure arrangement, the limiting member can fit a hole wall of the positioning hole after being inserted into the positioning hole, so as to avoid that the limiting member is prone to shake due to a gap between the limiting member and the hole wall of the positioning hole, and the limiting member can also fit a hole wall of the limiting hole after being inserted into the limiting hole, so as to avoid that the limiting member is prone to shake due to a gap between the limiting member and the hole wall of the limiting hole.

In an embodiment, at least a part of the limiting member is cylindrical.

In an embodiment, two grips are provided, and the two grips are located on two opposite sides of the support tube.

In an embodiment, the stem is configured to be connected to the front fork of the bicycle to control a travel direction of the wheel connected to the front fork.

In an embodiment, the stem is rotatably sleeved on the outer side circumference of the support tube, the limiting structure further includes a pressure spring and a fixing sleeve sleeved on the outer side circumference of the stem, a limiting cavity is arranged in the fixing sleeve, the limiting member includes an operating portion, a connecting portion, and a limiting portion connected in sequence, the connecting portion extends through the limiting cavity, the pressure spring is arranged in the limiting cavity and sleeves the connecting portion, one end of the pressure spring elastically abuts against the limiting portion, the other end of the pressure spring elastically abuts against an inner wall of the limiting cavity, the limiting portion can be inserted into the limiting hole and the positioning hole under the action of an elastic force of the pressure spring, and the operating portion is located outside the limiting cavity and configured to be operated by the user, so as to pull the limiting portion to overcome the elastic force of the pressure spring and retreat from the limiting hole and the positioning hole.

In an embodiment, the support tube is rotatably sleeved on the outer side circumference of the stem, the limiting structure further includes a pressure spring and a fixing sleeve sleeved on the outer side circumference of the support tube, a limiting cavity is arranged in the fixing sleeve, the limiting member includes an operating portion, a connecting portion, and a limiting portion connected in sequence, the connecting portion extends through the limiting cavity, the pressure spring is arranged in the limiting cavity and sleeves the connecting portion, one end of the pressure spring elastically abuts against the limiting portion, the other end of the pressure spring elastically abuts against an inner wall of the limiting cavity, the limiting portion can be inserted into the limiting hole and the positioning hole under the action of an elastic force of the pressure spring, and the operating portion is located outside the limiting cavity and configured to be operated by the user, so as to pull the limiting portion to overcome the elastic force of the pressure spring and retreat from the limiting hole and the positioning hole.

An embodiment of the present application further provides a bicycle, including a frame and the handlebar assembly according to any one of the above embodiments connected to the frame.

Since the bicycle includes the handlebar assembly according to any one of the above embodiments, the bicycle at least includes the following beneficial effects: the stem of the handlebar assembly may be fixed to the front fork of the bicycle for controlling the travel direction of the wheel on the front fork. When the bicycle is ridden, at the unlocking position, the handlebar is rotatable relative to the stem, and in this case, the whole handlebar can be rotated into the state of being substantially perpendicular to the wheel of the front fork, i.e., the state that the handlebar is substantially perpendicular to the frame, the limiting structure is then moved to the locking position to relatively fix the handlebar and the stem, and in this case, the handlebar can drive the stem to rotate together. It can be understood that this conforms to the bicycle using habits of the user during riding, the user faces the handlebar, and double hands can naturally rest on the handlebar in front of the body. If the bicycle is parked in the designated parking region, the number of the bicycles in the designated region is large, and the distances between the bicycles are small, the bicycle with the handlebar assembly according to the present application has advantages, the limiting member can be moved to the unlocking position, the handlebar can be rotated relative to the stem in this case, the handlebar can be rotated to the position where the handlebar is substantially parallel to the frame, that is, the handlebar is attached to the bicycle body, the front wheel does not need to rotate, and the front wheel can also be kept at the position where the front wheel is substantially parallel to the frame, thus reducing the size of the handlebar in the width direction of the bicycle body, reducing the size in the width direction of the bicycle body occupied by the inclined wheel, facilitating the parking and taking of the bicycle in the limited space, reducing the mutual interference and scratching between the bicycle and other adjacent vehicles, and reducing the risk of bicycle damage to the greatest extent.

### BRIEF DESCRIPTION OF THE DRAWINGS

In order to illustrate the technical solutions in the embodiments of the present application or the prior art more clearly, the drawings required for describing the embodiments or the prior art will be described briefly. Apparently, the following described drawings are merely for some embodiments of the present application, and other drawings can be derived from these drawings by those of ordinary skill in the art without any creative effort.

FIG. 1 is a schematic front view of a handlebar assembly according to an embodiment of the present application.

FIG. 2 is a perspective view of the handlebar assembly according to an embodiment of the present application.

FIG. 3 is another perspective view schematic structural diagram of the handlebar assembly according to an embodiment of the present application.

FIG. 4 is a sectional view and a partially enlarged view of the handlebar assembly according to an embodiment of the present application.

FIG. 5 is a perspective view of a handlebar in an embodiment of the present application.

FIG. 6 is a perspective view of a stem in an embodiment of the present application.

FIG. 7 is a cross-sectional view of the handlebar assembly according to an embodiment of the present application.

FIG. 8 is another cross-sectional view of the handlebar assembly according to an embodiment of the present application.

### REFERENCE SIGNS

10: handlebar assembly; 100: stem; 110: limiting hole; 111: first limiting hole; 112: second limiting hole; 120: guide bump; 200: handlebar; 210: grip; 220: support tube; 221: positioning hole; 222: guide sliding groove; 2221: first end; 2222: second end; 300: limiting structure; 310: limiting member; 311: operating portion; 312: connecting portion; 313: limiting portion; 320: fixing sleeve; 321: avoiding hole; 322: limiting cavity; 330: handle; 340: pressure spring.

### DETAILED DESCRIPTION

In order to make the aforementioned objects, features and advantages of the present application more apparent, the embodiments of the present application are described below in detail with reference to the accompanying drawings. In the following description, numerous specific details are set forth, so as to provide a thorough understanding of the present application. However, the present application may be implemented in many ways different from those described herein, those skilled in the art may make similar improvements without departing from the essence of the present application, and therefore, the present application is not limited to the examples disclosed below.

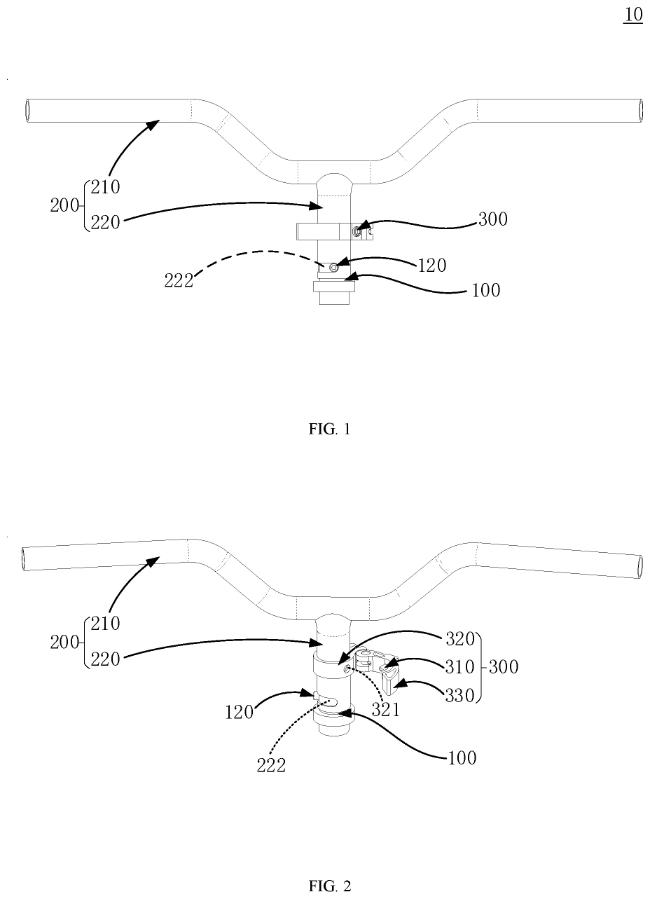

Referring to FIG. 1 to FIG. 6, in some embodiments, the present application provides a handlebar assembly 10, including a stem 100, a handlebar 200, and a limiting structure 300. A side circumference of the stem 100 is provided with a limiting hole 110, the handlebar 200 includes a grip 210 and a support tube 220 fixed to the grip 210, and a side circumference of the support tube 220 is provided with a positioning hole 221.

One of the support tube 220 and the stem 100 is rotatably sleeved with another. For example, in an embodiment, the support tube 220 is rotatably sleeved on an outer side circumference of the stem 100. For another example, in another embodiment, the stem 100 is rotatably sleeved on an outer side circumference of the support tube 220. The limiting structure 300 includes a limiting member 310 movably connected to the handlebar 200, and the limiting member 310 can move between an unlocking position and a locking position relative to the handlebar 200. As shown in FIG. 1 and FIG. 4, when the limiting member 310 is at the locking position, at least a part of the limiting member 310 is inserted into the positioning hole 221 and the limiting hole 110 simultaneously to lock the handlebar 200 and the stem 100. As shown in FIG. 2, when the limiting member 310 is at the unlocking position, the limiting member 310 is disengaged from the limiting hole 110 and the positioning hole 221, and the handlebar 200 is rotatable relative to the stem 100.

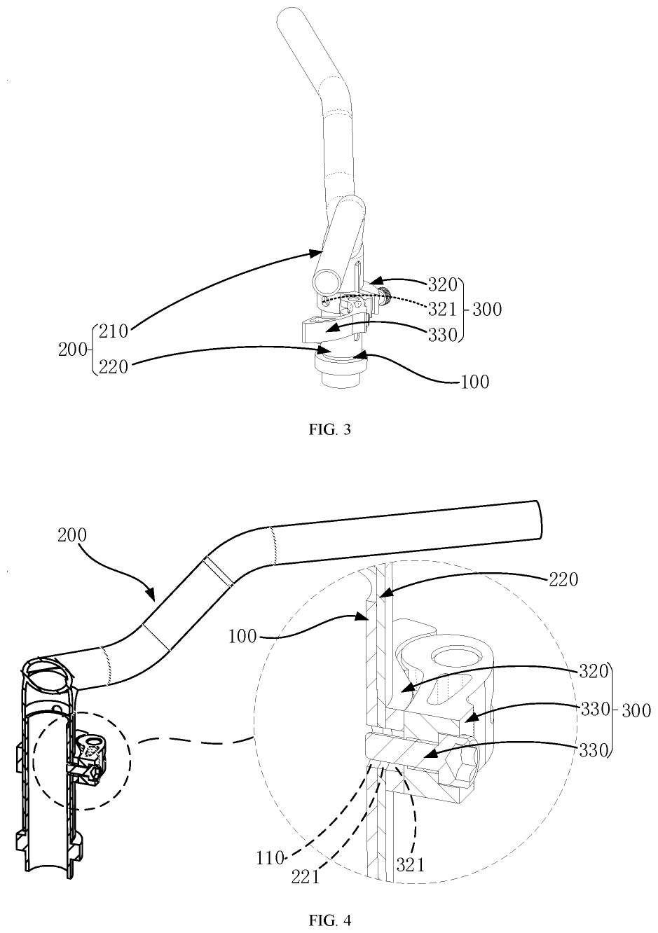

The above handlebar assembly 10 at least achieves the following beneficial effects: the stem 100 may be fixed to a front fork of a bicycle for controlling a travel direction of a wheel on the front fork. When the bicycle with the handlebar assembly 10 is ridden, at the unlocking position, the handlebar 200 is rotatable relative to the stem 100, as shown in FIG. 1, and in this case, the whole handlebar 200 can be rotated into a state of being substantially perpendicular to the wheel of the front fork, i.e., the handlebar 200 is substantially perpendicular to a frame, the limiting structure 300 is then moved to the locking position to relatively fix the handlebar 200 and the stem 100, and in this case, the handlebar 200 can drive the stem 100 to rotate together. It can be understood that this conforms to bicycle using habits of a user during riding, the user faces the handlebar 200, and two hands can naturally rest on the handlebar 200 in front of the body. If the bicycle with the handlebar assembly 10 is parked in a designated parking region, a number of bicycles in the designated region is large, and distances between the bicycles are small, the bicycle with the handlebar assembly 10 according to the present application has advantages. For example, the limiting member 310 can be moved to the unlocking position, the handlebar 200 can be rotated relative to the stem 100, as shown in FIG. 3, and the handlebar 200 can be rotated to a position where the handlebar 200 is substantially parallel to the frame, that is, the handlebar 200 is attached to a bicycle body, the front wheel does not need to rotate, and the front wheel can also be kept at a position where the front wheel is substantially parallel to the frame, thus reducing a size of the handlebar 200 in a width direction of the bicycle body, reducing a size in the width direction of the bicycle body occupied by the inclined wheel, facilitating parking and taking of the bicycle in a limited space, reducing mutual interference and scratching between the bicycle and other adjacent vehicles, and reducing the risk of bicycle damage to the greatest extent.

Specifically, as shown in FIG. 6, in some embodiments, the limiting holes 110 include a first limiting hole 111 and a second limiting hole 112. The first limiting hole 111 and the second limiting hole 112 are spaced apart along a circumferential direction of the stem 100. The locking positions include a first locking position and a second locking position. When the limiting member 310 is at the first locking position, the positioning hole 221 is aligned with the first limiting hole 111, and the limiting member 310 is inserted into the positioning hole 221 and the first limiting hole 111. When the limiting member 310 is at the second locking position, the positioning hole 221 is aligned with the second limiting hole 112, and the limiting member 310 is inserted into the positioning hole 221 and the second limiting hole 112. For example, when the bicycle with the handlebar assembly 10 is ridden, at the unlocking position, the handlebar 200 is rotatable relative to the stem 100, as shown in FIG. 1, and in this case, the whole handlebar 200 can be rotated into the state of being substantially perpendicular to the wheel of the front fork, i.e., the state that the handlebar 200 is substantially perpendicular to the frame, the limiting structure 300 is then moved to the first locking position to relatively fix the handlebar 200 and the stem 100, and in this case, the handlebar 200 can drive the stem 100 to rotate together. It can be understood that this conforms to the bicycle using habits of the user during riding, the user faces the handlebar 200, and the two hands can naturally rest on the handlebar 200 in front of the body. For another example, if the bicycle with the handlebar assembly 10 is parked in the designated parking region, the number of the bicycles in the designated region is large, and the distances between the bicycles are small, the bicycle with the handlebar assembly 10 according to the present application has advantages. For example, the limiting member 310 can be moved to the unlocking position, the handlebar 200 can be rotated relative to the stem 100 in this case, as shown in FIG. 3, and the handlebar 200 can be rotated to the position where the handlebar 200 is substantially parallel to the frame, that is, the handlebar 200 is adjacent to the bicycle body, the front wheel does not need to rotate, and the front wheel can also be kept at the position where the front wheel is substantially parallel to the frame, thus reducing the size of the handlebar 200 in the width direction of the bicycle body, reducing the size in the width direction of the bicycle body occupied by the inclined wheel, facilitating the parking and taking of the bicycle in the limited space, reducing the mutual interference and scratching between the bicycle and other adjacent vehicles, and reducing the risk of bicycle damage to the greatest extent. In order to prevent the handlebar 200 from swinging in a parking process, the limiting structure 300 can be moved to the second locking position, and the limiting member 310 is inserted into the positioning hole 221 and the second limiting hole 112 simultaneously, so that the handlebar 200 is kept fixed while being attached to the bicycle body.

More specifically, as shown in FIG. 6, in some embodiments, an axial extension line of the first limiting hole 111 and an axial extension line of the second limiting hole 112 are arranged to form an angle. For example, in the embodiment shown in FIG. 6, the axial extension line of the first limiting hole 111 and the axial extension line of the second limiting hole 112 form an included angle of 90 degrees. It may be understood that in a more preferred embodiment, the handlebar 200 located at the first locking position is substantially perpendicular to the front wheel during riding, and the handlebar 200 located at the second locking position is preferably substantially parallel to the bicycle body and the front wheel during parking. In other words, the handlebar 200 located at the first locking position is substantially perpendicular to the handlebar 200 located at the second locking position, and in order to achieve this effect, the axial extension line of the first limiting hole 111 and the axial extension line of the second limiting hole 112 are arranged to form the angle of 90 degrees in this embodiment.

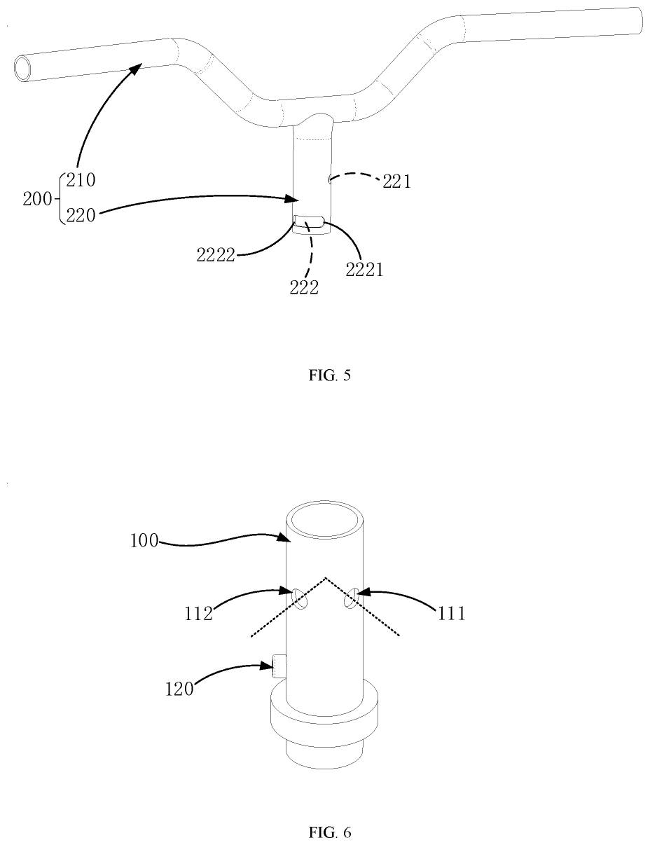

Referring to FIG. 1, FIG. 2, FIG. 5, and FIG. 6, in some embodiments, a guide bump 120 is further provided on an outer side circumference of the stem 100, a guide sliding groove 222 is formed in the side circumference of the support tube 220, and the guide bump 120 is slidably provided in the guide sliding groove 222. The guide bump 120 abuts against a groove wall of the guide sliding groove 222, so as to limit movement of the support tube 220 in an axial direction of the stem 100 and limit a rotation angle of the support tube 220 in the circumferential direction of the stem 100. The guide bump 120 is inserted into the guide sliding groove 222, and the guide bump 120 abuts against the groove wall of the guide sliding groove 222 in the axial direction of the stem 100, so that movement of the handlebar 200 and the stem 100 in the axial direction can be limited, and the handlebar 200 and the stem 100 are prevented from being separated. In addition, since a length extending direction of the guide sliding groove 222 is limited, a sliding stroke of the guide bump 120 in the guide sliding groove 222 is limited, therefore, a rotating stroke of the handlebar 200 relative to the stem 100 is also limited.

Further, as shown in FIG. 5, in some embodiments, the guide sliding groove 222 extends along the circumferential direction of the stem 100. The guide sliding groove 222 has a first end 2221 and a second end 2222 in the circumferential direction of the stem 100. The positioning hole 221 is aligned with the first limiting hole 111 when a groove wall of the first end 2221 of the guide sliding groove 222 abuts against the guide bump 120, and the positioning hole 221 is aligned with the second limiting hole 112 when a groove wall of the second end 2222 of the guide sliding groove 222 abuts against the guide bump 120. Such a structure arrangement has the advantages that, specifically, when the handlebar 200 rotates to the state of being substantially perpendicular to the front wheel, the guide bump 120 can be arranged to just abut against the groove wall of the first end 2221 of the guide sliding groove 222, the positioning hole 221 is just aligned with the first limiting hole 111, and in this case, the limiting structure 300 is inserted into the positioning hole 221 and the first limiting hole 111, and the handlebar 200 is fixed to the stem 100. That is, the limiting structure is quickly positioned to the first locking position. Similarly, when the handlebar 200 rotates to a state of being substantially parallel to the front wheel, the guide bump 120 can be arranged to just abut against the groove wall of the second end 2222 of the guide sliding groove 222, the positioning hole 221 is just aligned with the second limiting hole 112, and in this case, the limiting structure 300 is inserted into the positioning hole 221 and the second limiting hole 112, and the handlebar 200 is fixed to the stem 100. That is, the limiting structure is quickly positioned to the second locking position. In other words, the groove wall of the first end 2221 of the guide sliding groove 222 and the groove wall of the second end 2222 of the guide sliding groove 222 can abut against the guide bump 120, so as to achieve a positioning effect on relative rotation of the handlebar 200 and the stem 100, so that the user can conveniently rotate the handlebar 200 to the first locking position and the second locking position relative to the stem 100.

Further, in some embodiments, the guide bump 120 is a screw, and the guide bump 120 is threadedly connected to the side circumference of the stem 100.

Referring to FIG. 2 and FIG. 4, in some embodiments, the limiting structure 300 further includes a fixing sleeve 320 sleeved on an outer side circumference of the support tube 220 and a handle 330 rotatably connected to the fixing sleeve 320, and the limiting member 310 is provided on a side of the handle 330 adjacent to the support tube 220.

Specifically, as shown in FIG. 2, in some embodiments, a side circumference of the fixing sleeve 320 is further provided with an avoiding hole 321, the avoiding hole 321 is aligned with the positioning hole 221. When the limiting member 310 is at the locking position, the limiting member 310 at least partially extends through the avoiding hole 321 and the positioning hole 221, so as to be inserted into the limiting hole 110.

Specifically, as shown in FIG. 4, in some embodiments, the limiting member 310 is a pin, which extends through the handle 330 and is fixed to the handle 330.

Specifically, in some embodiments, the limiting member 310 is at least partially matched with the limiting hole 110, and the limiting hole 110 is matched with the positioning hole 221. With such a structure arrangement, the limiting member 310 can fit a hole wall of the positioning hole 221 after being inserted into the positioning hole 221, so as to avoid that the limiting member 310 is prone to shake due to a gap between the limiting member 310 and the hole wall of the positioning hole 221, and the limiting member 310 can also fit a hole wall of the limiting hole 110 after being inserted into the limiting hole 110, so as to avoid that the limiting member 310 is prone to shake due to a gap between the limiting member 310 and the hole wall of the limiting hole 110.

Specifically, in some embodiments, at least a part of the limiting member 310 is cylindrical.

Specifically, in some embodiments, the stem 100 is configured to be connected to the front fork of the bicycle to control a travel direction of the wheel connected to the front fork.

Specifically, in some embodiments, two grips 210 are provided, and the two grips 210 are located on two opposite sides of the support tube 220.

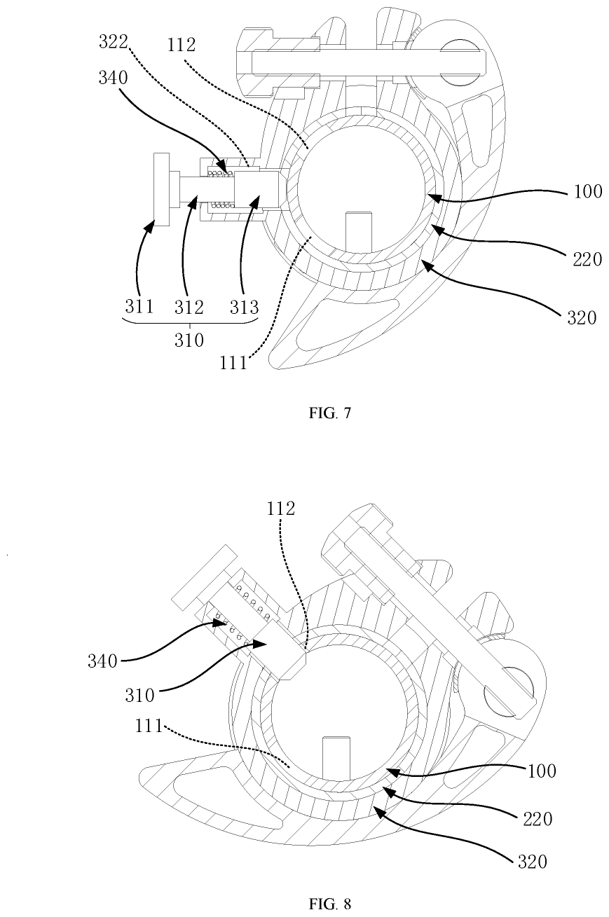

Referring to FIG. 7 and FIG. 8, in some embodiments, the support tube 220 rotatably sleeves the outer side circumference of the stem 100, the limiting structure 300 further includes a pressure spring 340 and a fixing sleeve 320 sleeved on the outer side circumference of the support tube 220. A limiting cavity 322 is provided in the fixing sleeve 320, the limiting member 310 includes an operating portion 311, a connecting portion 312, and a limiting portion 313 connected in sequence. The connecting portion 312 extends through the limiting cavity 322, the pressure spring 340 is arranged in the limiting cavity 322 and is sleeved on the connecting portion 312. One end of the pressure spring 340 elastically abuts against the limiting portion 313, the other end of the pressure spring 340 elastically abuts against an inner wall of the limiting cavity 322. The limiting portion 313 can be inserted into the limiting hole 110 and the positioning hole 221 subjected to an elastic force of the pressure spring 340, and the operating portion 311 is located outside the limiting cavity 322 and configured to be operated by the user, so as to pull the limiting portion 313 to overcome the elastic force of the pressure spring 340 and disengaged from the limiting hole 110 and the positioning hole 221.

In some other embodiments, the stem 100 rotatably is sleeved on the outer side circumference of the support tube 220. The limiting structure 300 further includes a pressure spring 340 and a fixing sleeve 320 sleeved on the outer side circumference of the stem 100. A limiting cavity 322 is arranged in the fixing sleeve 320, the limiting member 310 includes an operating portion 311, a connecting portion 312, and a limiting portion 313 connected in sequence. The connecting portion 312 extends through the limiting cavity 322, the pressure spring 340 is arranged in the limiting cavity 322 and is sleeved on the connecting portion 312. One end of the pressure spring 340 elastically abuts against the limiting portion 313, the other end of the pressure spring 340 elastically abuts against an inner wall of the limiting cavity 322. The limiting portion 313 can be inserted into the limiting hole 110 and the positioning hole 221 subjected to an elastic force of the pressure spring 340, and the operating portion 311 is located outside the limiting cavity 322 and configured to be operated by the user, so as to pull the limiting portion 313 to overcome the elastic force of the pressure spring 340 and disengaged from the limiting hole 110 and the positioning hole 221.

The present application further provides a bicycle, including a frame and the handlebar assembly 10 according to any one of the above embodiments connected to the frame.

Since the bicycle includes the handlebar assembly 10 according to any one of the above embodiments, the bicycle at least includes the following beneficial effects: the stem 100 of the handlebar assembly 10 may be fixed to the front fork of the bicycle for controlling the travel direction of the wheel on the front fork. When the bicycle is ridden, at the unlocking position, the handlebar 200 is rotatable relative to the stem 100, and in this case, the whole handlebar 200 can be rotated into the state of being substantially perpendicular to the wheel of the front fork, i.e., the handlebar 200 is substantially perpendicular to the frame, the limiting structure 300 is then moved to the locking position to relatively fix the handlebar 200 and the stem 100, and in this case, the handlebar 200 can drive the stem 100 to rotate together. It can be understood that this conforms to the bicycle using habits of the user during riding, the user faces the handlebar 200, and the two hands can naturally rest on the handlebar 200 in front of the body. If the bicycle is parked in the designated parking region, the number of the bicycles in the designated region is large, and the distances between the bicycles are small, the bicycle with the handlebar assembly 10 according to the present application has advantages, the limiting member 310 can be moved to the unlocking position, the handlebar 200 can be rotated relative to the stem 100 in this case, the handlebar 200 can be rotated to the position where the handlebar 200 is substantially parallel to the frame, that is, the handlebar 200 is adjacent to the bicycle body, the front wheel does not need to rotate, and the front wheel can also be kept at the position where the front wheel is substantially parallel to the frame, thus reducing the size of the handlebar 200 in the width direction of the bicycle body, reducing the size in the width direction of the bicycle body occupied by the inclined wheel, facilitating the parking and taking of the bicycle in the limited space, reducing the mutual interference and scratching between the bicycle and other adjacent vehicles, and reducing the risk of bicycle damage to the greatest extent.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the specification.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the protection scope of the present application should be subject to the appended claims.

In descriptions of the present application, it should be understood that, directions or positional relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential” etc. are based on orientations or positional relationships shown in the accompanying drawings, and they are used only for describing the present application and for description simplicity, but do not indicate or imply that an indicated device or element must have a specific orientation or be constructed and operated in a specific orientation. Therefore, it cannot be understood as a limitation on the present application.

In addition, the terms such as “first” and “second” are used herein for purposes of description and are not intended to indicate or imply relative importance or significance or to imply the number of indicated technical features. Thus, the feature defined with “first” and “second” may include at least one of this feature explicitly or implicitly. In the description of the present application, “a plurality of” means at least two, such as two, three, or the like, unless otherwise specified.

In the present application, unless specified or limited otherwise, the terms “mounted”, “connected”, “coupled”, and “fixed” and the like are understood broadly. It may be, for example, fixed connections, detachable connections, or integral connections; may also be mechanical or electrical connections; may also be direct connections or indirect connections via intervening structures; may also be communication or an interaction relationship of two elements, unless otherwise specified. The above terms can be understood by those skilled in the art according to specific situations.

In the present application, unless specified or limited otherwise, the description that a first feature is “on” or “below” a second feature may mean that the first feature is in direct contact with the second feature, or the first feature and the second feature are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

It should be noted that when an element is referred to as being “fixed on” or “provided at” another element, the element may be directly located on the other element or an intermediate element may exist. If one element is considered to be “connected” to another element, it may be directly connected to the other element or an intermediate element may co-exist. As used herein, the terms “vertical”, “horizontal”, “upper”, “lower”, “left”, “right”, or the like, are for purposes of illustration only and do not denote a sole embodiment.

In the description of the specification, references to “an embodiment”, “other embodiments”, or the like, mean that a particular feature, structure, material, or characteristic described in connection with the embodiment or example is included in at least one embodiment or example of the present application. In this specification, schematic depictions of the above terms do not necessarily refer to the same embodiment or example. Unless defined otherwise, all technical and scientific terms used herein have the same meanings as are commonly understood by those skilled in the art. The terms used herein in the specification of the present application are for the purpose of describing specific embodiments only but not intended to limit the present application.

What claimed is:

1. A handlebar assembly, comprising:
a stem, a side circumference of the stem being provided with a limiting hole;
a handlebar comprising a grip and a support tube fixed to the grip, one of the support tube and the stem being rotatably sleeved with another, and a side circumference of the support tube being provided with a positioning hole; and
a limiting structure comprising a limiting member movably connected to the handlebar, the limiting member being capable of moving between an unlocking position and a locking position relative to the handlebar, wherein when the limiting member is at the locking position, at least a part of the limiting member is inserted into the positioning hole and the limiting hole simultaneously to lock the handlebar and the stem, and when the limiting member is at the unlocking position, the limiting member is disengaged from the limiting hole and the positioning hole, such that the handlebar is rotatable relative to the stem.

2. The handlebar assembly according to claim 1, wherein the limiting holes comprise a first limiting hole and a second limiting hole, the first limiting hole and the second limiting hole are spaced apart along a circumferential direction of the stem; the locking positions comprise a first locking position and a second locking position, when the limiting member is at the first locking position, the positioning hole is aligned with the first limiting hole, the limiting member is inserted into the positioning hole and the first limiting hole, and when the limiting member is at the second locking position, the positioning hole is aligned with the second limiting hole, and the limiting member is inserted into the positioning hole and the second limiting hole.

3. The handlebar assembly according to claim 2, wherein an axial extension line of the first limiting hole and an axial extension line of the second limiting hole are arranged to form an angle.

4. The handlebar assembly according to claim 3, wherein the axial extension line of the first limiting hole and the axial extension line of the second limiting hole are arranged to form the angle of 90 degrees.

5. The handlebar assembly according to claim 2, wherein an outer side circumference of the stem is provided with a guide bump, the side circumference of the support tube is provided with a guide sliding groove, the guide bump is slidably provided in the guide sliding groove, the guide bump abuts against a groove wall of the guide sliding groove to limit movement of the support tube in an axial direction of the stem, so as to limit a rotation angle of the support tube in the circumferential direction of the stem.

6. The handlebar assembly according to claim 5, wherein the guide sliding groove extends along the circumferential direction of the stem, the guide sliding groove has a first end and a second end in the circumferential direction of the stem, when a groove wall of the first end of the guide sliding groove abuts against the guide bump, the positioning hole is aligned with the first limiting hole, and when a groove wall of the second end of the guide sliding groove abuts against the guide bump, the positioning hole is aligned with the second limiting hole.

7. The handlebar assembly according to claim 5, wherein the guide bump is a screw, and the guide bump is threadedly connected to the side circumference of the stem.

8. The handlebar assembly according to claim 1, wherein the limiting structure further comprises a fixing sleeve sleeved on an outer side circumference of the support tube, and a handle rotatably connected to the fixing sleeve, and the limiting member is provided on a side of the handle adjacent to the support tube.

9. The handlebar assembly according to claim 8, wherein a side circumference of the fixing sleeve is further provided with an avoiding hole aligned with the positioning hole, and when the limiting member is at the locking position, the limiting member at least partially extends through the avoiding hole and the positioning hole, so as to be inserted into the limiting hole.

10. The handlebar assembly according to claim 8, wherein the limiting member is a pin, and the pin extends through the handle and is fixed to the handle.

11. The handlebar assembly according to claim 1, wherein the limiting member is at least partially matched with the limiting hole, and the limiting hole is matched with the positioning hole.

12. The handlebar assembly according to claim 1, wherein at least a part of the limiting member is cylindrical.

13. The handlebar assembly according to claim 1, wherein two grips are provided, and the two grips are located on two opposite sides of the support tube.

14. The handlebar assembly according to claim 1, wherein the stem is configured to be connected to a front fork of a bicycle, so as to control a travel direction of a wheel connected to the front fork.

15. The handlebar assembly according to claim 1, wherein the stem is rotatably sleeved on an outer side circumference of the support tube, the limiting structure further comprises a pressure spring and a fixing sleeve sleeved on the outer side circumference of the stem, a limiting cavity is provided in the fixing sleeve, the limiting member comprises an operating portion, a connecting portion, and a limiting portion that are connected in sequence, the connecting portion extends through the limiting cavity, the pressure spring is provided in the limiting cavity and is sleeved on the connecting portion, one end of the pressure spring elastically abuts against the limiting portion, another end of the pressure spring elastically abuts against an inner wall of the limiting cavity, the limiting portion is inserted into the limiting hole and the positioning hole subjected to an elastic force of the pressure spring, and the operating portion is located outside the limiting cavity and configured to be operated by a user, so as to pull the limiting portion to overcome the elastic force of the pressure spring and is disengaged from the limiting hole and the positioning hole.

16. The handlebar assembly according to claim 1, wherein the support tube is rotatably sleeved on an outer side circumference of the stem, the limiting structure further comprises a pressure spring and a fixing sleeve sleeved on the outer side circumference of the support tube, a limiting cavity is provided in the fixing sleeve, the limiting member comprises an operating portion, a connecting portion, and a limiting portion that are connected in sequence, the connecting portion extends through the limiting cavity, the pressure spring is arranged in the limiting cavity and sleeves the connecting portion, one end of the pressure spring elastically abuts against the limiting portion, another end of the pressure spring elastically abuts against an inner wall of the limiting cavity, the limiting portion is inserted into the limiting hole and the positioning hole subjected to an elastic force of the pressure spring, and the operating portion is located outside the limiting cavity and configured to be operated by a user, so as to pull the limiting portion to overcome the elastic force of the pressure spring and is disengaged from the limiting hole and the positioning hole.

17. A bicycle comprising a frame and the handlebar assembly according to claim 1 connected to the frame.
